(19) United States
(12) Patent Application Publication
(10) Pub. No.: US 2006/0019216 A1
(43) Pub. Date: Jan. 26, 2006

(54) Dental retractor and method of use to produce anatomically accurate jaw models and dental prostheses

(75) Inventors: Eitan Priluck, Portland, ME (US); Leonard Marotta, West Islip, NY (US); Michael Vincent Franchell, Albany, NY (US); Steven Defabio Pigliacelli, Huntington, NY (US); Crispin Bernard Weinberg, Brookline, MA (US); Khaled Elsaid, Brighton, MA (US)

Correspondence Address: GIBBONS, DEL DEO, DOLAN, GRIFFINGER & VECCHIONE, 1 RIVERFRONT PLAZA, NEWARK, NJ, 07102-5497, US

(73) Assignee: Biomedical Modeling, Inc.

(21) Appl. No.: 11/185,546

(22) Filed: Jul. 20, 2005

Related U.S. Application Data
(60) Provisional application No. 60/589,460, filed on Jul. 20, 2004.

(51) Int. Cl. A61C 5/00

(52) U.S. Cl. 433/140

(57) ABSTRACT

An improved retractor comprising one or more cheek positioning members and one or more lip positioning members has been developed. This retractor makes it possible to conduct X-ray CT or similar scans of the jaw and to construct anatomically accurate models of bone, teeth and gingival tissue. What is provided is an improved retractor useful when conducting CT scans of the jaw of an individual requiring a dental implant and models to be constructed that are anatomically accurate with respect to bone, teeth and gingival (soft) tissue. Drill guides, and prostheses are constructed with the jaw models.

### RELATED APPLICATION

This Application claims priority of U.S. Provisional Ser. No. 60/589,460 filed Jul. 20, 2004, incorporated herein by reference.

### BACKGROUND OF THE INVENTION

In modern dentistry, dental implants are the primary method of treatment to replace missing teeth. Much progress has been made since early attempts by Egyptians to replace pulled teeth with cleaned teeth. Prostheses and bridges have been developed to replace missing pieces. Materials suitable for implantation have been developed over the last twenty-five years and implants made from materials such as titanium and alloys of titanium have provided a significant improvement in implant therapy. The historical use of such modern implants has resulted in the confirmation that it is extremely important to determine the exact place where the hole must be drilled on the jaw bone, and the tilt thereof when designing and placing implants. Different radiographic tests have been used in order to study—prior to any surgery—all special parameters of the maxilla (upper jaw) or mandible (lower jaw) of each patient, so as to minimize failure risks.

Successful outcome of the treatment, osseointegration of the implant, depends heavily on precise presurgical planning. Since the functional load in implants can be high, it is important that the implant be placed in a position where it can contact cortical bone and at an angle where the forces are as perpendicular as possible. Selection of the appropriate size and inclination of the implant in both a bucco-lingual and mesio-distal direction requires precise knowledge of the anatomy of the proposed site, including its dimension in all planes, the presence of knife-edge ridges and undercuts, as well as the location of anatomic structures, such as the nasal fossae, the maxillary sinus, and the mandibular canal. An evaluation of the thickness of the cortical bone and the density of the medullary bone is also important to the success of the implant. Various imaging modalities have been used in the dentomaxillofacial fields over the past few decades.

U.S. Pat. No. 5,320,529 to Pompa described an apparatus and method for locating and surgically positioning a hole for an implant and holder in a jawbone of a patient includes constructing a model of a jawbone. A structure is located within the model depicting variations in density within the jawbone. A hole is drilled into the model based on the location of the structure. A rod is placed into the hole and a guide template is fabricated around the model which forms a bore around the rod. The guide template is placed onto the jawbone of the patient and a hole is drilled through the bore into the jawbone to make a hole in the jawbone along the same path as the hole in the model for receiving the implant and holder.

Pompa performs a computed tomography (CT) scan on the individual requiring a dental implant. The information from the scan can then be processed to generate a clear acrylic, stereolithographic (SLA) model showing both interior structures and exterior contours of the upper and lower jaw bones. The stereolithographic process is discussed in detail in the article, “Stereolithographic Models for Surgical Planning: Preliminary Report” by Stoker, Mankovich and Valentino which appears in the Journal of Oral and Maxillofacial Surgery, 50:466-471, 1992, the subject matter which is incorporated by reference into this patent. Model surgery is then performed on the SLA model. The model can be used to prepare a surgical guide template and the permanent implant. The complete surgical process is known in the art and described for example in U.S. Pat. No. 5,320,529. The scanning process described in Pompa did not produce a model with soft gingival tissue. The process of Pompa did not distinguish between gingival, lip, tongue and cheek tissue thereby making it impossible to construct an anatomically correct model that contained gingival tissue.

In other approaches to planning dental implants and restorations, esthetic and functional planning is largely based on casts made from impressions, which depict only the outer surfaces of gums and existing teeth. These are frequently mounted in an articulator in order to evaluate bite. Surgical planning (implant placement, angle, depth, drill guides, ets.) is typically based on radiographic data such as panoramic X-ray, CT or MRI.

Elaborate methods are required to register (line up) the esthetic and surgical information. For example, custom scanning prostheses are fabricated which show the location of teeth on a planned esthetic restoration. This information is then combined in a computer simulation for planning implants. The simulated implant locations are then used to fabricate drill guides. The surgeon must interpret the images and renderings on the 2-dimensional computer screen, in terms of his or her understanding of the actual 3-dimensional anatomy they represent.

The present invention enables both esthetic and surgical planning and fabrication of guides and restorations to take place directly upon, or with the aid of models which accurately emulate the gums, teeth and jaw.

### BRIEF SUMMARY OF THE INVENTION

An improved retractor comprises one or more cheek positioning members and one or more lip positioning members has been developed. This retractor makes it possible to conduct X-ray CT or similar scans of the jaw and to construct anatomically accurate models of bone, teeth and gingival tissue. The cheek positioning member(s) applies pressure to the inside of the cheek pushing it away from the teeth and gingiva. The lip positioning member may push or cup the lips away from the gingiva. Alternatively, the lip positioning member may form a physical barrier or wall between the gingiva and the lips. Optionally and preferably, the improved retractor will have a tongue positioning member to comfortably hold the tongue away from gingival tissue. In still another optional embodiment, the retractor would also hold the tongue away from the palate. In alternative embodiments, the improved retractor may be constructed to permit unobstructed imagining of the entire jaw, upper jaw, the lower jaw, left side upper jaw, left side lower jaw or both and right side upper jaw, right side lower jaw or both. Preferably, the improved retractor will not contact the gingival tissue. More preferably, the improved retractor will be radiolucent. Most preferably, the improved retractor will provide a scan image having a different contrast than those of teeth, bone and gingival tissue.

The improved retractor may be provided in a number of different sizes, as an adjustable retractor or even as a custom fit retractor. The improved retractor is preferably rigid or stiff such that the patient will be able to not move the tongue or jaw during the scanning process.

The apparatus of the present invention solves the shortcomings in the art in a simple and straightforward device. What is provided is an improved, optionally radiolucent retractor useful when conducting CT scans of the jaw of an individual requiring a dental implant. The improved retractor allows CT scans to be conducted and models to be constructed that are anatomically accurate with respect to bone, teeth and gingival (soft) tissue. The retractor permits the patient's lips, cheeks and tongue to be held comfortably away from teeth and gingiva, thereby permitting an unobstructed X-ray CT image of jaw bone, teeth and gingiva to be taken and a model constructed therefrom accurately modeling bone, teeth and gingiva. Suitable model building techniques include:

Stereolithography (SLA)—Is a process using photosensitive resins cured by a laser that traces the parts cross sectional geometry layer by layer. SLA produces accurate models with a variety of material choices.

SLS (Selective Laser Sintering)—Process using photosensitive powders sintered by a CO2 laser that traces the parts cross sectional geometry layer by layer. SLS creates accurate and durable models but finish out of machine is relatively poor.

FDM (Fused Deposition Modeling)—Process using molten plastics or wax extruded by a nozzle that traces the models cross sectional geometry layer by layer. FDM creates tough models that are ideal for functional usage.

Three-Dimensional Printing (3DP)—Ink-jet based process that prints the models cross sectional geometry on layers of powder spread on top of each other. This process enables models to be built quickly and affordably. Models may also be printed in color.

Computer Numerical Control (CNC) Milling is a common form of model production. CNC mills can perform the functions of drilling and often turning. Cutting tools of various profile shapes are available including square, rounded, and angled. A wide variety of part shapes and geometries are possible.

Photopolymer Jetting—This process is similar to stereolithography in that models are made with a photosensitive resin. The difference is in how the resin is applied and cured to build the model.

Digital Light Projection (DLP)—a modified stereolithography process in which the part's cross sectional geometry is cured by projecting light from an optical semiconductor chip such as Digital Micromirror Device (DMD chip).

The advantages of advance planning are well known. They include: Improved functional and esthetic results, reduced chair time for the patient, lowered risk of implant and prosthetic failure, lowered risk of alveolar nerve damage, more accurate estimates of costs and time, lower cost of the entire procedure, reduced risk of unexpected difficulties during surgery & restorations, reduced risk of complications and reduced surgical time. The surgeon may rehearse the surgery and thereby refine procedures before operating on a patient. This is generally known as performing “model surgery”.

Furthermore, temporary or permanent prosthetic restorations can also be fabricated upon, or with the aid of accurate models which emulate the gums, teeth and jaw.

### BRIEF DESCRIPTION OF THE DRAWINGS

FIG. 1 is a perspective view of an embodiment of the device of the invention.

FIG. 2 is a front view of the device of FIG. 1 as it would be placed in the mouth.

FIG. 3 is a bottom view of the device illustrating its placement with respect to the upper jaw.

FIG. 4 is a perspective view of an embodiment of the device of the invention.

FIG. 5 is a front view of the device of FIG. 4.

FIG. 6 is a side cross section view of the device of FIG. 4 placed in the mouth.

FIG. 7 A is a front view of an embodiment of the device of the invention.

FIG. 7 B is a bottom view of an embodiment of the invention.

FIG. 7 C is a top view of an embodiment of the invention.

### DETAILED DESCRIPTION OF THE INVENTION

The improved, retractor of the present invention allows CT and similar imaging scans to be conducted of the jaw and models to be constructed that are anatomically accurate with respect to bone, teeth and gingival (soft) tissue. The retractor permits the patient's lips, cheeks and optionally the tongue to be held comfortably away from teeth and gingiva, thereby permitting an unobstructed image of jaw bone, teeth and gingiva to be taken and a stereolithographic or similar rapid prototyping model to be constructed there from accurately modeling bone, teeth and gingiva.

The improved retractor comprises one or more cheek positioning members and one or more lip positioning members. The cheek positioning member(s) apply pressure to the inside of the cheek pushing it away from the teeth and gingiva. The lip positioning member may push or cup and hold the lips away from the gingiva. Alternatively, the lip positioning member may form a physical barrier or wall between the gingiva and the lips. Optionally and preferably, the improved retractor will have a tongue positioning member to comfortably hold the tongue away from gingival tissue and teeth. In still another optional embodiment, the retractor would also hold the tongue away from the palate. In alternative embodiments, the improved retractor may be constructed to permit unobstructed imagining of the entire jaw, upper jaw, the lower jaw, left side upper jaw, left side lower jaw or both and right side upper jaw, right side lower jaw or both. Preferably, the improved retractor will not contact the gingival tissue. More preferably the improved retractor will not contact gingival tissue and teeth. In a preferred embodiment, the retractor will be constructed of rigid material. In another preferred embodiment, the retractor is composed of a material having a different image contrast than those of teeth, bone and gingival tissue. A different image contrast is such that the retractor will be clearly differentiated in the image produced from each scanning modality from the image produced by that modality for tissue, teeth and bone.

The improved retractor may be provided in a number of different sizes, as an adjustable retractor or even as a custom fit retractor. The retractor is fabricated from polymeric materials using various methods known in the art such as injection molding, vacuum forming and the like of suitable materials such as acrylic resins, nylon, PET resins, styrene, polycarbonate, low and high density polyethylene, polyester resins and the like.

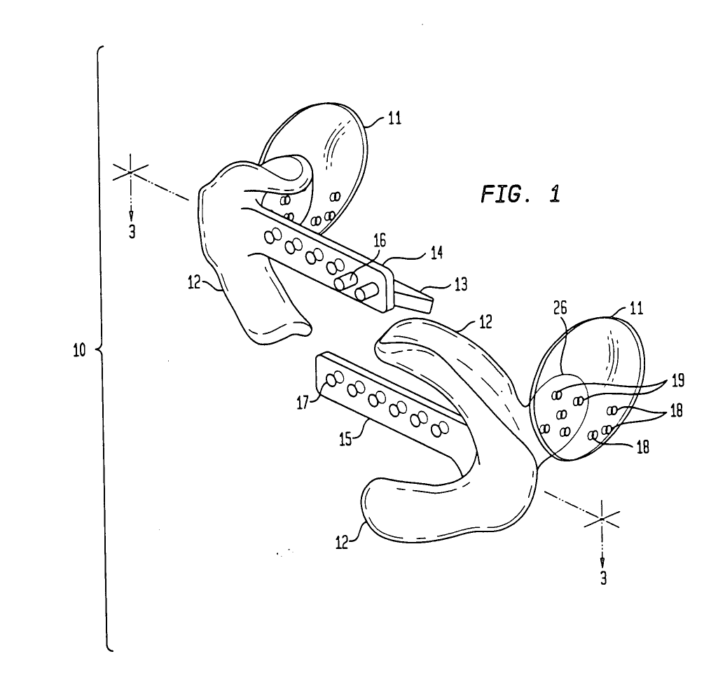

FIGS. 1-7 illustrate preferred embodiments of the apparatus of the present invention by numerals 10, 20 and 30.

FIG. 1 illustrates an adjustable retractor. The retractor may be formed in two pieces or more. When two pieces are used, the two pieces are identical except that one piece has pegs on connector 14 and the other piece has matching holes on connector piece 14. The retractor 10 comprises cheek positioning members 11, lip positioning member 12, tongue positioning member 13, connector 14 with pegs 16 arranged along its longitudinal center line and connector 15 with holes 17, for receiving pegs 16, said holes arranged along the longitudinal center line of connector 15. Cheek positioning member 11 is shaped to comfortably fit the patient's mouth structure and may therefore be round, oval, rectangular, square or combinations of the foregoing. In the two piece version of the retractor, cheek positioning member 11 may be permanently attached to lip positioning member 12. In an alternate embodiment, the lip positioning member is adjustably attached to the lip positioning member. FIG. 1 illustrates a preferred adjustable method of attachment. Hole(s) 18 in the cheek positioning member 11 may be attached with one or more pins, not shown, to matching holes 19 in tab 26 on lip positioning member 12. Alternate means of attachment such as hook and loop fasteners, temporary adhesives and the like may be used.

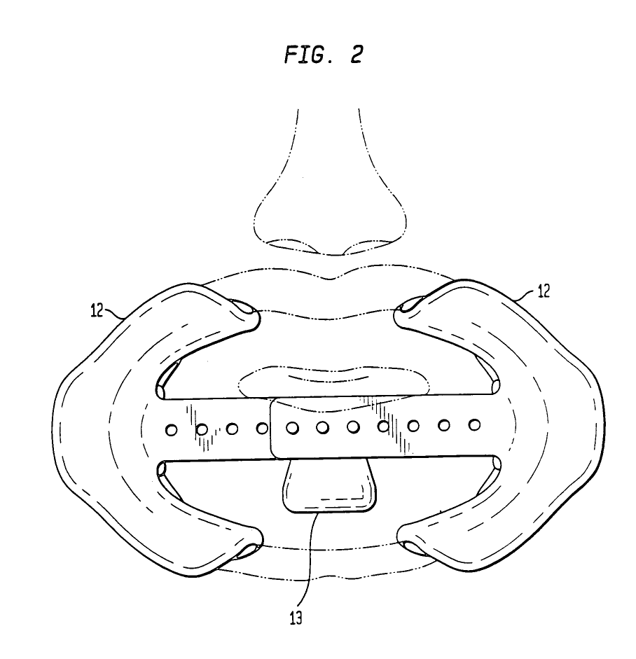

FIG. 2 illustrates the apparatus of FIG. 1 assembled and placed in the mouth of a patient. Lip positioning members 12 are holding the lips open and pushed up and to the side. Tongue positioning member 13 is holding the tongue above the lower jaw but not in contact with the teeth, lips and palate.

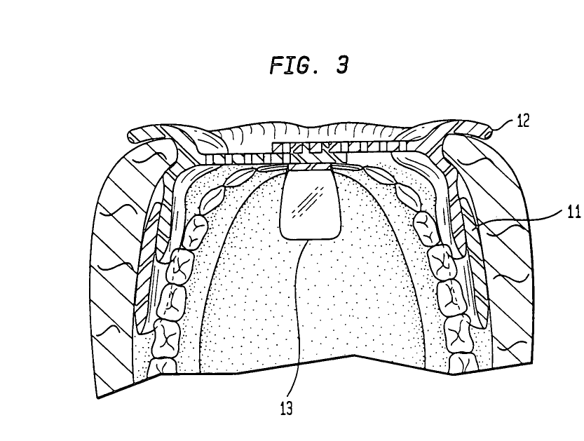

FIG. 3 is a bottom view illustrating cheek positioning member 11 holding the cheek away from the teeth and gums. Lip positioning member 12 is holding the lips away from the teeth and gums.

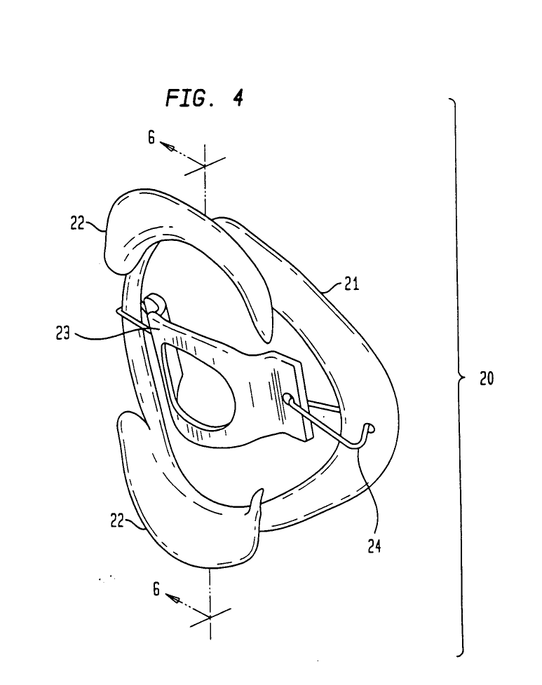

FIG. 4 illustrates another retractor 20 with a cheek positioning member 21, lip positioning member 22, tongue positioning member 23 and tongue positioning member support 24.

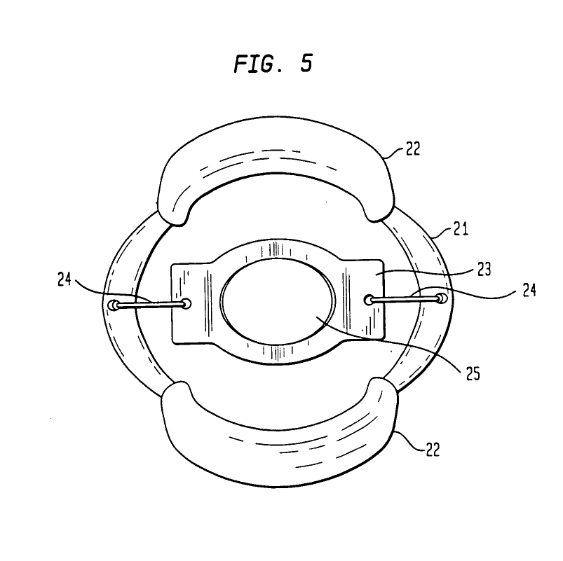

FIG. 5 illustrates a frontal view of the retractor of FIG. 4 with tongue positioning member 23 containing tongue holding opening 25.

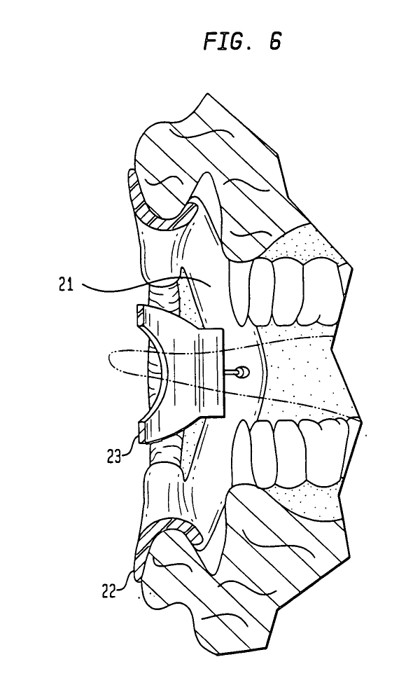

FIG. 6 illustrates a cross sectional view of the retractor of FIG. 4 placed in the mouth of a patient. Lip positioning member 22 is holding the lips open and pushed up and to the side. Tongue positioning member 23 is holding the tongue above the lower jaw but not in contact with the teeth, lips and palate. Cheek positioning member 21 is holding the cheek away from the gums and teeth.

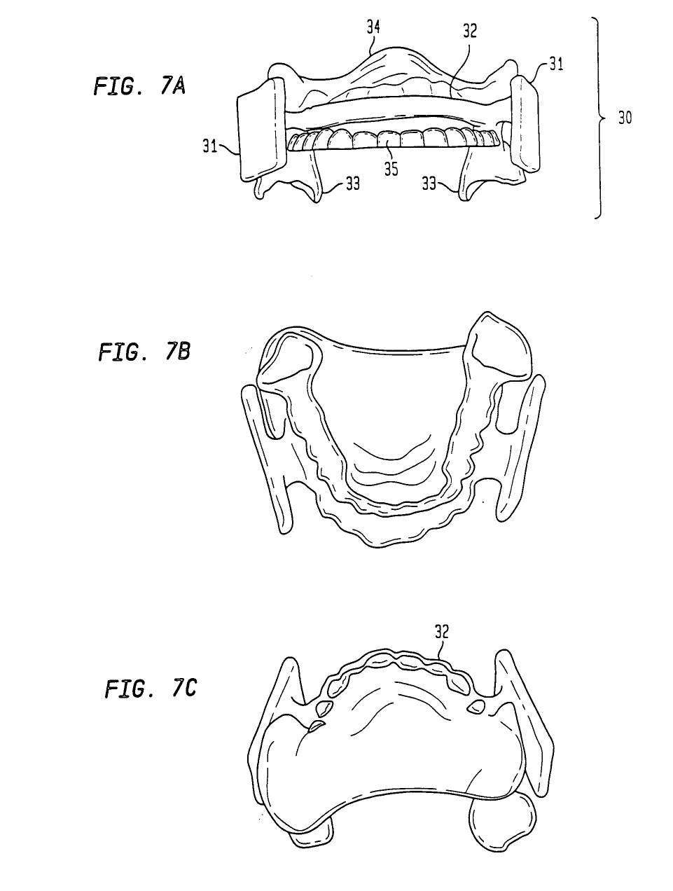

FIGS. 7A-C illustrate a custom fit upper jaw retractor 30. The retractor comprises cheek positioning member 31, lip positioning member 32, a pair of positioning legs 33, a palate bridge 34 and row of imitation teeth 35. The teeth are an optional feature of the custom retractor and are useful for patients with no teeth or at least some missing teeth. The optional teeth may be radio opaque or radiolucent. The positioning legs hold the retractor above the lower jaw and prevent closure of the jaw during the scanning process. This type of device can usually be made from an impression of the individual's mouth. The illustrated retractor is intended to facilitate a scan of the lower jaw. A retractor to facilitate a scan of the upper jaw may similarly be constructed.

The inventive retractor is placed into the mouth of an individual in need of a dental implant. The jaw is then scanned with a suitable scanning modality. Computerized imaging software is utilized to create a computer image of the jaw. The information from the scan can then be processed to generate a model of the jaw showing both interior structures and exterior contours of bone, teeth and gingival tissue. A single model may be composed of clear, translucent and opaque materials as desired to accentuate the various structures within the model. In a preferred embodiment, the bone and teeth are modeled in a hard material to simulate the structure and physical properties of bone and teeth and the gingival tissue can be modeled using a softer material to simulate tissue.

The preferred scanning modality is X-ray computed tomography (CT) with cone beam computed tomography being more preferred. Magnetic resonance imaging (MRI), 3 D ultrasound or other modality having a slice thickness giving sufficient contrast and spatial resolution to determine the position and shape of anatomical structures to within 1 mm can be used. A scan slice thickness of about 1 mm is required to prepare models of sufficient detail. Preferably, the slice thickness will be 0.5 mm or less. More preferably the slice thickness will be about 0.2 mm. Still more preferably, the slice thickness will be about 0.1 mm and most preferably, the slice thickness will be less than 0.1 mm.

The scan data is processed by procedures well known in the art to produce computer (digital) and rapid prototyping models of bony structures (mandible and maxilla or either one), teeth and overlying gingival tissues and optionally of the palate.

There are a number of suitable rapid prototyping techniques available. The most well known are:

Stereolithography—Process using photosensitive resins cured by a laser that traces the parts cross sectional geometry layer by layer. SLA produces accurate models with a variety of material choices.

The SLA rapid prototyping process was the first entry into the rapid prototyping field during the 1980s and continues to be the most widely used technology. The SLA method uses liquid photopolymer resins that are solidified by a laser to generate models. An SLA machine consists of the following parts: a build platform, resin vat, recoating blade, ultraviolet laser and a scanning device. The build platform, which translates up and down, is suspended in the vat of resin. The build platform is placed slightly under the surface of the resin. A laser beam hardens the resin when it makes surface contact. A scanning device, which controls the laser beam, traces the first cross section of the prototype. The laser will trace the model as well as support structures necessary to support any overhanging features. Once the first cross section is complete, the build platform lowers one layer thickness into the vat. A recoating blade is then used to hasten the process of covering the cross section with liquid resin. Once the first cross section is suitably covered, the next cross section is scanned. This process repeats until the model is complete. Once the model is completed, the build platform is raised and the excess resin is allowed to drain. Depending on the material, a post cure operation is sometimes needed to attain the desired material properties. After any final curing, the support structures that were built to prevent any sagging are removed.

SLS (Selective Laser Sintering)—Process using photosensitive powders sintered by a CO2 laser that traces the parts cross sectional geometry layer by layer. SLS creates accurate and durable models but finish out of machine is relatively poor.

Typically in SLS, a thermoplastic powder is spread by a roller over the surface of a build cylinder. The piston in the cylinder moves down one object layer thickness to accommodate the new layer of powder. The powder delivery system is similar in function to the build cylinder. Here, a piston moves upward incrementally to supply a measured quantity of powder for each layer.

A laser beam is then traced over the surface of this tightly compacted powder to selectively melt and bond it to form a layer of the object. The fabrication chamber is maintained at a temperature just below the melting point of the powder so that heat from the laser need only elevate the temperature slightly to cause sintering. This greatly speeds up the process. The process is repeated until the entire object is fabricated.

After the object is fully formed, the piston is raised to elevate it. Excess powder is simply brushed away and final manual finishing may be carried out. No supports are required with this method since overhangs and undercuts are supported by the solid powder bed. That's not the complete story, though. It may take a considerable length of cool-down time before the part can be removed from the machine. Large parts with thin sections may require as much as two days of cooling time.

SLS offers the key advantage of making functional parts in essentially final materials. However, the system is mechanically more complex than stereolithography and most other technologies. A variety of thermoplastic materials such as nylon, glass filled nylon, and polystyrene are available. Surface finishes and accuracy are not quite as good as with stereolithography, but material properties can be quite close to those of the intrinsic materials. The method has also been extended to provide direct fabrication of metal and ceramic objects and tools.

Since the objects are sintered they are porous. It may be necessary to infiltrate the part, especially metals, with another material to improve mechanical characteristics

FDM (Fused Deposition Modeling)—Process using molten plastics or wax extruded by a nozzle that traces the models cross sectional geometry layer by layer. FDM creates tough models that are ideal for functional usage.

FDM is the second most widely used rapid prototyping technology, after stereolithography. A plastic filament is unwound from a coil and supplies material to an extrusion nozzle. The nozzle is heated to melt the plastic and has a mechanism which allows the flow of the melted plastic to be turned on and off. The nozzle is mounted to a mechanical stage which can be moved in both horizontal and vertical directions.

As the nozzle is moved over the table in the required geometry, it deposits a thin bead of extruded plastic to form each layer. The plastic hardens immediately after being squirted from the nozzle and bonds to the layer below. The entire system is contained within a chamber which is held at a temperature just below the melting point of the plastic.

Several materials are available for the process including ABS and investment casting wax. ABS offers good strength, and more recently polycarbonate and poly(phenyl)sulfone materials have been introduced which extend the capabilities of the method further in terms of strength and temperature range. Support structures are fabricated for overhanging geometries and are later removed by breaking them away from the object. A water-soluble support material which can simply be washed away is also available.

The method is office-friendly and quiet. FDM is fairly fast for small parts on the order of a few cubic inches, or those that have tall, thin form-factors. It can be very slow for parts with wide cross sections, however. The finish of parts produced with the method have been greatly improved over the years, but aren't quite on a par with stereolithography. The closest competitor to the FDM process is probably three dimensional printing. However, FDM offers greater strength and a wider range of materials than at least the implementations of 3DP which are most closely comparable.

Three-Dimensional Printing (3DP)—Ink-jet based process that prints the models cross sectional geometry on layers of powder spread on top of each other. This process enables models to be built quickly and affordably. Models may also be printed in color.

3D printing is similar to the SLS method except instead of using a laser to sinter material together a print head dispenses a solution to bind the powder together. A typical system consists of the following parts: feed piston, build piston, spreading apparatus and print head gantry. The feed piston is used to measure and dispense powder that is spread across the build piston by means of a spreading apparatus. Once the initial layer is spread, the lowest cross section of the part is printed by spraying a binder solution on the powder substrate by means of an inkjet print head on the print head gantry. After the initial layer is printed, the feed piston raises one layer thickness and the build piston lowers one thickness and the spreader then spreads a layer of powder over the first cross section. The print heads are then used to print the next layer. This process continues until the model is completed. Once the model has been completed and the binder has been allowed to dry sufficiently, the model can be removed and excess powder can be blown off of the model. Like SLS, no support structures are needed because the excess powder on the build piston acts as a support during the build. Once the model is de-powdered, the model can be finished using infiltrants, varying from wax, cyanoacrylate and epoxy materials, to increase strength and achieve a desirable finish. 3DP technology allows models to be built very quickly and inexpensively.

The preferred printing materials are plaster or starch. The plaster based system, in general, is more durable and gives better resolution. After the model is printed, it should be infiltrated. The infiltrates are preferably wax, cyanoacrylate (superglue) and epoxy. The printing process allows models to be printed in full color, just like an inkjet printer.

Computer Numerical Control (CNC) Milling is a common form of model production. CNC mills can perform the functions of drilling and often turning. Cutting tools of various profile shapes are available including square, rounded, and angled. A wide variety of part shapes and geometries are possible. A model is formed by applying drilling and turning procedures. CNC Mills are classified according to the number of axes that they possess. Axes are labeled as x and y for horizontal movement, and z for vertical movement, as shown in this view of a manual mill table. A standard manual light-duty mill is typically assumed to have four axes:
Table x.
Table y.
Table z.
Milling Head z.

A five-axis CNC milling machine has an extra axis in the form of a horizontal pivot for the milling head. This allows extra flexibility for machining with the end mill at an angle with respect to the table. A six-axis CNC milling machine would have another horizontal pivot for the milling head, this time perpendicular to the fifth axis.

Photopolymer Jetting—This process is similar to stereolithography in that models are made with a photosensitive resin. The difference is in how the resin is applied and cured to build the model.

Currently, Photopolymer Jetting technology uses a jetting head to accurately build each layer at a resolution of 600×300 dpi. Each layer is only 16 microns (0.0006 inches) thick, which is about ⅕ that of stereolithography layers. The jetting head slides back and forth along the X-axis like a line printer, depositing a single-layer of photopolymer onto the build tray. Immediately after building each layer, UV bulbs alongside the jetting bridge emit UV light, curing and hardening each layer subsequently.

Two different materials are used for building: one material is used for the actual model, while a second, gel-like photopolymer material is used for support. When the model is completed, a water jet easily removes this support material. .

Because of the super thin layer thickness, the resulting parts are very accurate and have a very smooth surface finish.

Digital Light Projection (DLP)—a modified stereolithography process in which the model's cross sectional geometry is cured by projecting light from an optical semiconductor chip such as Digital Micromirror Device (DMD chip). The chip can project light to selected regions, so the entire layer's cross sectional geometry is exposed at one time. The layer is fully cured and the part is built upside-down on a moveable plate, rather than a bath of liquid resin. This reduces the need for support structures and eliminates entrapped resin in voids.

The constructed models of the present invention are then used to plan features of implants and implant systems, such as location, angle, size, shape, style and depth of implants and implant systems. For purposes of planning, models of the upper and lower jaw may be used together or separately. Models may be mounted in an articulator or similar device using known methods. Models made by this process may be used in place of casts made from impressions.

The models may be used to fabricate frameworks, temporary and final restorations, drill guides, cutting guides, templates, mold, dam or other devices directly on the models. Techniques for constructing all of the above are of general knowledge in the art.

Jawbone models can be made to include several classes of bone (Class 1-4). Preferably the models will be made to include classes 1 and 2, which hold implants well. Various types of bone may be indicated in the model by coloration or cross hatching.

Support structures are often used in fabrication of models by many of the rapid prototyping techniques. Most are cleaned from the model as part of post-fabrication processing. However, it may not be possible to remove some support structures located in cavities. Such structures may be colored to distinguish them from bone, teeth and gingival tissue and other anatomical structures.

Models may be fabricated which reveal internal anatomy such as the mandibular nerve channel and alveoli (tooth sockets). Such models may be sectioned in two or more parts to reveal the internal structure.

Gingival tissues are preferably modeled from flexible materials which would then be used to overlay the bony structure of the model (made from inflexible material). The models may be translucent, transparent or opaque and using color to highlight various structures within the model. The flexible material may then be poked through, drilled and cut such that pin gauges, and pin markers and similar devices may be inserted therein to implement placement of restorations, drill guides, cutting guides, templates, mold, dam or other devices directly on the models.

The models may be used to highlight other features of the oral cavity such as tumors and abscesses. The structure of these features may be highlighted in the model by use of color, different materials and cross hatching.

Dentistry increasingly relies on accurate three-dimensional representation of the teeth and jaw for diagnostic and treatment purposes. Since the models developed using the radiolucent retractor, display, hard and flexible structures as well and internal structures of the oral cavity, A surgeon can easily locate optimum locations for cutting, drilling and attaching templates and restorations. The surgeon may use the model to perform “model surgery” on the model before performing actual surgery. Such procedures are routinely performed by oral surgeons.

It should be noted that any surgical procedure requiring precise knowledge of optimal bone dimensional anatomy and any procedure performed in bone in the vicinity of a vital structure, i.e., nerve, artery, vein, tumor, cyst etc., can benefit from the method and apparatus disclosed herein.

A surgical guide template is made, for example, from clear acrylic by techniques well known in the art. U.S. Pat. No. 5,320,529 describes one such process. The entire patent is incorporated herein by reference.

Models fabricated from scans using the inventive radiolucent retractor can be used in a variety of procedures.

A method for locating and surgically positioning a hole for an implant and holder in a jawbone of a patient comprising the steps of:
i.) constructing model of the jaw including jawbone, inner anatomic structures and tissue;
ii.) locating a structure within the model depicting variations in density within the jawbone;
iii.) drilling a hole into the model based on the location of the structure;
iv.) placing a rod into the hole. Optionally, the rod includes a simulated implant analog and a holder.
v.) fabricating a guide template around the model and forming a bore around the rod; and
vi.) placing the guide template onto the jawbone of the patient and drilling through the bore into the jawbone to make a hole in the jawbone along the same path as the hole in the model for receiving the implant and holder.

In an alternative embodiment, placing the guide template onto the soft tissue and/or teeth of the patient and drilling through the bore into the jawbone to make a hole in the jawbone along the same path as the hole in the model for receiving the implant and holder.

The method of constructing a model of the jaw comprises:

inserting a radiolucent retractor apparatus into the mouth wherein said retractor apparatus comprises:
a) one or more cheek positioning members; and
b) one or more lip positioning members;

scanning the jawbone with a computerized tomography scan to create a computer image;

tracing anatomical structures within the image; and

constructing a model of the jawbone based on the anatomical structures and information reformatted from the computerized tomography scan. The model may be constructed by any of the model building techniques described above. Stereolithography is a preferred technique.

In an alternate embodiment of the method of constructing a model of the jaw, the retractor apparatus will further comprise a tongue positioning member.

Prior to the present invention, a dental technician would make a wax up, this is a wax model of the prosthesis, make a cast of the wax up, melt out the wax then make a casting, usually in acrylic of the prosthesis. This is a provisional restoration. The dentist would then place the provisional restoration into the patient's mouth at the time the implants were placed into the mouth. Since the exact positioning of the implants was not known in advance, the dentist would place the implants into the jaw then drill the acrylic casting to fit free hand. All of this is done while the patient is in the chair. The result was a time consuming process resulting in a close but generally not optimum fit of the provisional prosthesis. The provisional prosthesis is left in place until the jaw has healed around the implant(s).

The patient would return at a later date to be fitted with the final prosthesis. The final prosthesis must be drilled very accurately because it will be a load bearing device intended to last many years. The final prosthesis is generally made of ceramic or a metal such as gold coated with a ceramic.

An advantage of the present invention is that the provisional restoration will be provided to the dentist with the holes already drilled into the restoration. The provisional restoration will be fitted directly to the inventive model. The inventive model will have been drilled and have implants placed in the jaw. Because the jaw model will allow visualization and the exploration of alternate implant sites, the best position for the implants may be determined without risk to the patient. The provisional prosthesis will then be placed and accurately drilled to fit the model. This results in the patient being immediately fitted with a provisional prosthesis that is as accurately drilled and positioned as the permanent prosthesis will be. Patient chair time is reduced as the dentist does not have to drill the prosthesis in the office. The final prosthesis may be made at the same time as the provisional prosthesis. Provisional prostheses and permanent prostheses made utilizing the method described above are accurately fit to the model and because the model is a precise, anatomically accurate reproduction of the jaw including soft tissue, these prosthetic devices will fit better, last longer and reduce patient chair time. Reduced chair time will reduce patient anxiety.

An articulator as a “dental machine” that works as close as practical to the way the jaw works. Generally, dental models taken with impressions and poured in dental stone are placed on the machine either for examination and diagnosis, or to construct dental appliances. Special records are taken to accurately position the dental models on the articulator. The facebow record is a measurement from the upper teeth to the joints. The centric relation or bite record is a measurement of where the teeth are positioned with the joints positioned correctly before the teeth actually come into contact.

Various dental articulators are known in the art to which a pair of dental models or casts are mounted which simulate the movement of the human jaw. Typically, dental articulators are utilized by dentists or dental technicians to create an accurately fitting dental prosthesis, such as a crown, bridge, or cap. Dental articulators are used to mount castings of a patient's teeth which are used as a model for the creation of the dental prosthesis. In preparing the dental casts, a dentist normally makes a negative impression of the patient's teeth, which may be a partial or full arch impression. This negative impression serves as a mold for developing a casting of the patient's teeth. The negative impression is filled with a pourable casting stone which is allowed to harden and thereby form a replica of the patient's teeth. The upper and lower castings may then be attached to an articulator which allows the opposing casts to be moved toward or away from one another.

The prostheses of the present invention may be mounted on the inventive models and the models mounted in an articulator. The articulator can then be used in the conventional way to adjust the final shape and position of the prosthesis before finalizing the design. The result is a prosthetic device that is fit as accurately as possible to the exact jaw characteristics of the patient.

The foregoing embodiments are presented by way of example only; the scope of the invention is to be limited only by the appended claims.

We claim:

1. An improved retractor apparatus, for positioning the jaw such that the gingival tissue is not in contact with the cheeks or lips comprising:
i.) one or more cheek positioning members; and
ii.) one or more lip positioning members.

2. The retractor apparatus of claim 1 wherein the retractor apparatus is composed of radiolucent materials.

3. The retractor apparatus of claim 1 wherein the retractor apparatus is composed of rigid materials.

4. The retractor apparatus of claim 1 wherein the retractor apparatus further comprises a tongue positioning member.

5. The retractor apparatus of claim 1 wherein the retractor is composed of a material having a different image contrast than those of teeth, bone and gingival tissue.

6. An improved retractor apparatus, for use during X-ray computed tomography of the jaw comprising:
i.) one or more cheek positioning members; and
ii.) one or more lip positioning members.

7. A method for locating and surgically positioning a hole for an implant and holder in a jawbone of a patient comprising the steps of:
i.) constructing model of the jaw including jawbone, inner anatomic structures and tissue;
ii.) locating a structure within the model depicting variations in density within the jawbone;
iii.) drilling a hole into the model based on the location of the structure;
iv.) placing a rod into the hole;
v.) fabricating a guide template around the model and forming a bore around the rod; and
vi.) placing the guide template onto a portion of the jaw of the patient and drilling through the bore into the jawbone to make a hole in the jawbone along the same path as the hole in the model for receiving the implant and holder.

8. The method according to claim 7, wherein the rod includes a simulated implant analog and a holder.

9. The method according to claim 8, wherein said step of constructing a model of the jaw comprises:
inserting a radiolucent retractor apparatus into the mouth wherein said retractor apparatus comprises:
c) one or more cheek positioning members; and
d) one or more lip positioning members;
scanning the jaw with a scanning modality to create a computer image;
tracing anatomical structures within the image; and
constructing a model of the jaw based on the anatomical structures and information reformatted from the computerized scan.

10. The method according to claim 7, wherein the potion of the jaw of a patient is the jawbone.

11. The method according to claim 7, wherein the potion of the jaw of a patient is the gingival tissue.

12. The method according to claim 7, wherein the potion of the jaw of a patient is the teeth.

13. The method of claim 9, wherein the scanning modality is selected for the group consisting of X-ray computed tomography, magnetic resonance imaging (MRI), and 3 D ultrasound.

14. The method of claim 9, wherein the scanning modality is X-ray computed tomography.

15. The method of claim 9, wherein the scanning modality is X-ray cone beam computed tomography.

16. A method of creating a model of a jaw comprising;
inserting a retractor apparatus into the mouth wherein said retractor apparatus comprises:
a) one or more cheek positioning members; and
b) one or more lip positioning members;
scanning the human jaw with a scanning modality having a slice thickness sufficient to determine the position and shape of anatomical structures to within 1 mm;
processing scan data to produce computer and rapid prototyping models of bony structures, teeth and of overlying gingival tissues.

17. The method according to claim 16, wherein the retractor further comprises a tongue positioning member.

18. The method according to claim 16, wherein the retractor is constructed of a radiolucent material.

19. The method of creating a model of a jaw of claim 16 in which the rapid prototyping model is made by a method selected from the group consisting of stereolithography, solid ground forming, selective laser sintering, fused deposition modeling, 3D printing, CNC milling, photopolymer jetting, digital light projection and the like.

20. The method of claim 16 wherein the slice thickness is about 1 mm.

21. The method of claim 16 wherein the slice thickness is about 0.5 mm.

22. The method of claim 16 wherein the slice thickness is about 0.2 mm.

23. The method of claim 16 wherein the slice thickness is about 0.1 mm.

24. The method of claim 16 wherein the slice thickness is less than 0.1 mm.

25. A method of creating a model of a jaw as recited in claim 16 in which the rapid prototyping model is made by stereolithography.

26. A method of creating a model of a jaw as recited in claim 16 in which the rapid prototyping model is made by solid ground forming.

27. A method of creating a model of a jaw as recited in claim 16 in which the rapid prototyping model is made by selective laser sintering.

28. A method of creating a model of a jaw as recited in claim 16 in which the rapid prototyping model is made by fused deposition modeling.

29. A method of creating a 6 model of a 6 jaw as recited in claim 16 in which the rapid prototyping model is made by 3D printing.

30. A method of creating a model of a jaw as recited in claim 16 in which the rapid prototyping model is made by CNC milling.

31. A method of creating a model of a jaw as recited in claim 16 in which the rapid prototyping model is made by photopolymer jetting.

32. A method of creating a model of a jaw as recited in claim 16 in which the rapid prototyping model is made by digital light projection.

33. An apparatus for locating and surgically positioning a hole for an implant and holder in a jawbone of a patient comprising:
a jaw model including gingival tissue and inner anatomic structures formed by a method of scanning the jaw by inserting a retractor apparatus into the mouth wherein said retractor apparatus comprises:
e) one or more cheek positioning members; and
f) one or more lip positioning members;
with a scanning modality and constructing a model including gingival tissue and a structure within said model depicting variations in density within the jawbone;
means for locating and drilling a hole in said model based on the location of said structure;
a rod placed into the hole; and
a guide template disposed on said jaw model including a bore formed around said rod so that when said template is placed on a portion of the jaw of the patient, a drill is guided by said template bore into the jawbone along the same path as the hole in said model to form a hole for receiving the implant and holder.

34. The method according to claim 33, wherein the portion of the jaw of a patient is the jawbone.

35. The method according to claim 33, wherein the portion of the jaw of a patient is the gingival tissue.

36. The method according to claim 33, wherein the portion of the jaw of a patient is the teeth.

37. The apparatus of claim 33 wherein the retractor apparatus further comprises a tongue positioning member.

38. An accurate model of a jaw comprising:
a jawbone;
an inner anatomic structures; and
a tissue;
wherein the model structure of jawbone, inner anatomic structures and tissue are formed by a method comprising inserting a retractor apparatus into the mouth wherein said retractor apparatus comprises:
a) one or more cheek positioning members; and
b) one or more lip positioning members;
scanning the jaw with a scanning modality having a slice thickness sufficient to determine the position and shape of anatomical structures to within 1 mm;
processing scan data to produce computer and rapid prototyping models of bony structures, teeth and of overlying gingival tissues.

39. The model of claim 38, wherein the radiolucent retractor further comprises a tongue positioning member.

40. The method of claim 38, wherein the slice thickness is about 1 mm.

41. The method of claim 38, wherein the slice thickness is about 0.5 mm.

42. The method of claim 38, wherein the slice thickness is about 0.2 mm.

43. The method of claim 38, wherein the slice thickness is about 0.1 mm.

44. The method of claim 38, wherein the slice thickness is less than 0.1 mm.

45. The method of claim 38, wherein the scanning modality is selected for the group consisting of X-ray computed tomography (CT), magnetic resonance imaging (MRI), and 3 D ultrasound.

46. A method for planning and fabricating a provisional dental restoration for the jaw of a patient comprising the steps of:
i.) constructing model of the jaw including jawbone, inner anatomic structures and tissue;
ii) locating a structure within the model depicting variations of density within the jawbone;
iii) drilling a hole into the model based on the location of the structure;
iv.) placing a rod in the hole;
v.) forming a wax-up of the proposed restoration on the model and forming a bore around the rod;
vi.) fabricating restoration from the wax-up.

47. The method of claim 46, wherein a duplicate of the wax-up is mounted on the model and optimized in an articulator.

48. A method for locating and surgically positioning a frame work in the jaw of a patient comprising the steps of:
i.) constructing model of the jaw including jawbone, inner anatomic structures and tissue;
ii) locating a structure within the model depicting variations of density within the jawbone;
iii) drilling a hole into the model based on the location of the structure;
iv.) placing a rod in the hole;
v.) forming a wax-up of the proposed frame on the model and forming a bore around the rod;
vi.) fabricating the frame from the wax-up; and
vii.) drilling a hole in the patients jaw in the same position as the hole drilled into the model in step (iii.);
viii.) placing a rod in the hole; and
ix.) attaching the frame to the jaw.

49. A method for planning and fabricating a final dental prosthetic restoration for the jaw of a patient comprising the steps of:
i.) constructing model of the jaw including jawbone, inner anatomic structures and tissue;
ii) locating a structure within the model depicting variations of density within the jawbone;
iii) drilling a hole into the model based on the location of the structure;
iv.) placing a rod in the hole;
v.) forming a wax-up of the proposed restoration on the model and forming a bore around the rod;
vi.) fabricating restoration from the wax-up.

50. The method of claim 49, wherein a duplicate of the wax-up is mounted on the model and optimized in an articulator.

51. A method for planning and fabrication a dental frame for prosthetic restoration comprising:
i.) constructing model of the jaw including jawbone, inner anatomic structures and tissue;
ii) locating a structure within the model depicting variations of density within the jawbone;
iii) drilling a hole into the model based on the location of the structure;
iv.) placing a rod in the hole;
v.) forming a wax-up of the proposed frame on the model and forming a bore around the rod; and
vi.) fabricating the frame from the wax-up.
